(19) United States
(12) Patent Application Publication
(10) Pub. No.: US 2010/0055305 A1
(43) Pub. Date: Mar. 4, 2010

(54) METHOD FOR MAKING LIGHT BLOCKING PLATE

(75) Inventor: HSIN-HUNG CHUANG, Taipei Hsien (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/342,292

(22) Filed: Dec. 23, 2008

(30) Foreign Application Priority Data
Sep. 4, 2008 (CN) 200810304370.9

(51) Int. Cl. B05D 5/06

(52) U.S. Cl. 427/162

(57) ABSTRACT

A method for making a plurality of light blocking plates is provided. Firstly, a plurality of conical frustums are formed on a metal substrate, and each of the conical frustums tapers in a direction away from the metal substrate. Secondly, an opaque to-be-solidified film is formed on the metal substrate, and each of the conical frustums extends through the to-be-solidified film. Thirdly, the to-be-solidified film is solidified. Fourthly, the solidified film is separated from the metal substrate and the conical frustums, thus obtaining a light blocking plate module comprising a plurality of light blocking plates. Lastly, the light blocking plate module is cut into a plurality of individual light blocking plates.

### CROSS-REFERENCE TO RELATED APPLICATION

This application is related to the commonly-assigned copending application: Ser. No. ______, entitled “METHOD FOR MAKING LIGHT BLOCKING PLATE” (attorney docket number US22626). The Disclosure of the above-identified application is incorporated herein by reference.

### BACKGROUND

1. Technical Field

The present invention relates to a method for making the light blocking plate.

2. Description of Related Art

Nowadays, lens modules have been widely used in various portable electronic devices. The lens modules of portable electronic devices have become smaller and smaller in size. Accordingly, it is required that optical elements (e.g., a light blocking plate) used in the lens module have a smaller size/volume.

A typical light blocking plate is made by processing a plastic/metal tape. The thickness of the light blocking plate is limited by the thickness of the plastic/metal tape. The thickness of the light blocking plate is generally larger than 30 μm. Such a light blocking plate may not meet the demand for the miniature of the lens module.

Therefore, a new method for making the light blocking plate is desired to overcome the above mentioned problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, top plan view of a light blocking plate made by a method according to an exemplary embodiment.

FIG. 2 is a schematic, cross-sectional view of the light blocking plate of FIG. 1, taken along the line TI thereof.

FIGS. 3-10 are schematic views showing successive stages of a method for making the light blocking plate shown in FIG. 1.

### DETAILED DESCRIPTION OF THE EMBODIMENTS

Embodiments will now be described in detail below with reference to the drawings.

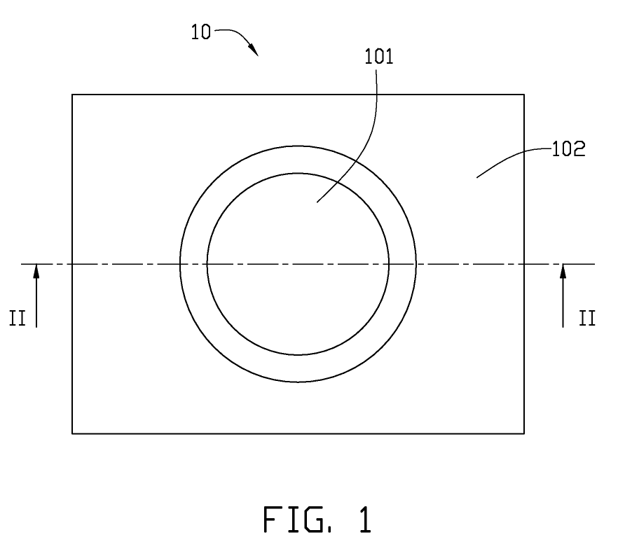

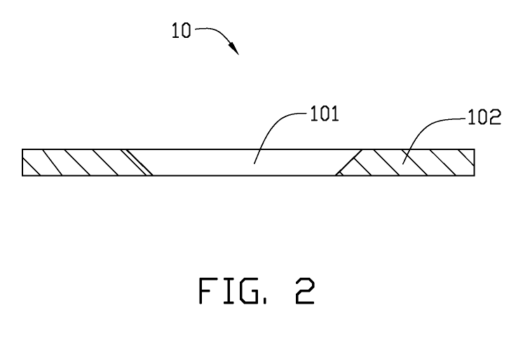

Referring to FIGS. 1 and 2, a light blocking plate 10 made by a method according to an exemplary embodiment, is shown. The light blocking plate 10 includes a though hole 101 defined at the center and an opaque portion 102 surrounding the through hole 101. The light blocking plate 10 is comprised of a polydimethylsiloxane (PDMS) and a blackening agent. Because the PDMS is light pervious, a blackening agent is added to the PDMS to create the opaque effect to block light. The blackening agent can be a carbon black or a toluene. In addition, the light blocking plate 10 can further be comprised of a hardener.

A method for making the light blocking plate 10 will be described in detail as follows.

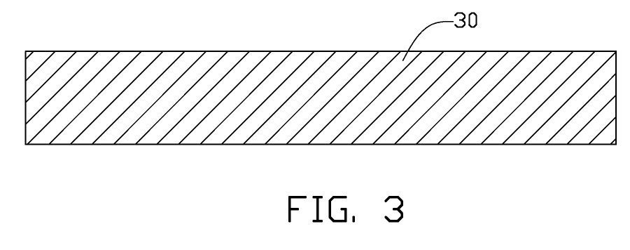

Referring to FIG. 3, a metal substrate 30 (e.g., an aluminum substrate) is firstly provided.

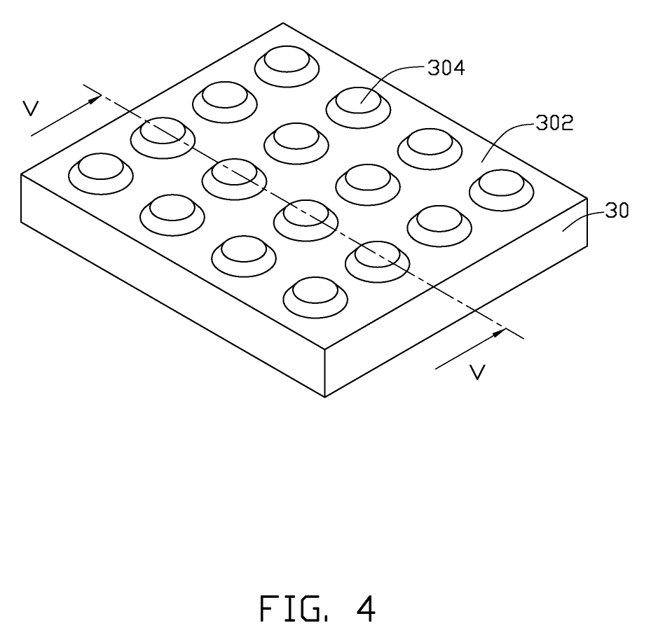

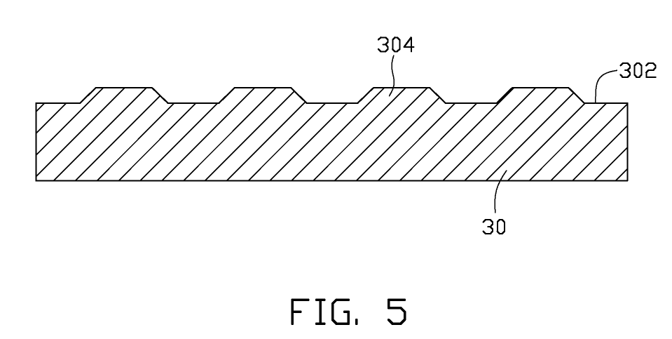

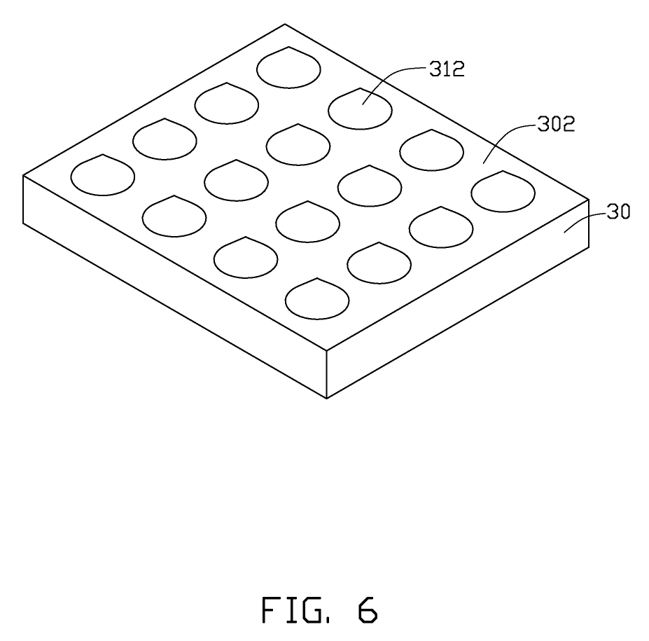

Referring to FIGS. 4-5, the metal substrate 30 is processed by ultra-precision machining to form a plurality of conical frustums 304. Each conical frustum 304 tapers in a direction away from the metal substrate 30. Alternatively, the metal substrate 30 can also be processed to form a plurality of cones 310 instead of conical frustums 304, as seen in FIG. 6.

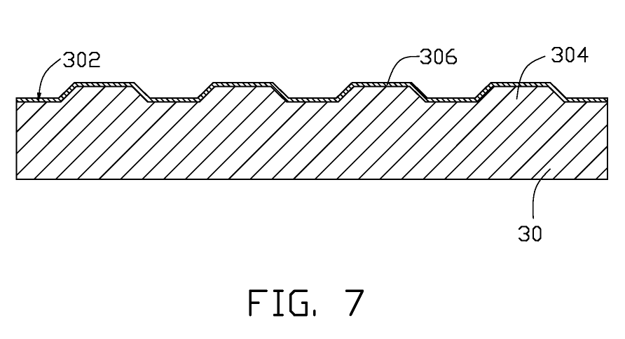

Referring to FIG. 7, a release agent layer 306 is formed on a surface 302 of the metal substrate 30, and covers the conical frustum 304.

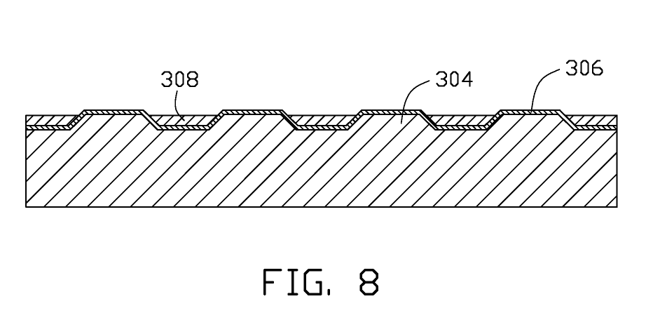

Referring to FIG. 8, an opaque to-be-solidified film 308 is formed on the release agent layer 306. A length of each conical frustum 304 is larger than a thickness of the to-be-solidified film 308 so that each conical frustum 304 extends through the to-be-solidified film 308. In the present embodiment, the to-be-solidified film 308 is made of a PDMS and a blackening agent. Because the PDMS is light pervious, a blackening agent is added to the PDMS to create the opaque effect to block light. The blackening agent can be a carbon black or a toluene. A thickness of the to-be-solidified film 308 is in an approximate range from 10 μm to 30 μm. The to-be-solidified film 308 can be formed by spin coating. In spin coating process, the thickness of the to-be-solidified film 308 can be effectively controlled.

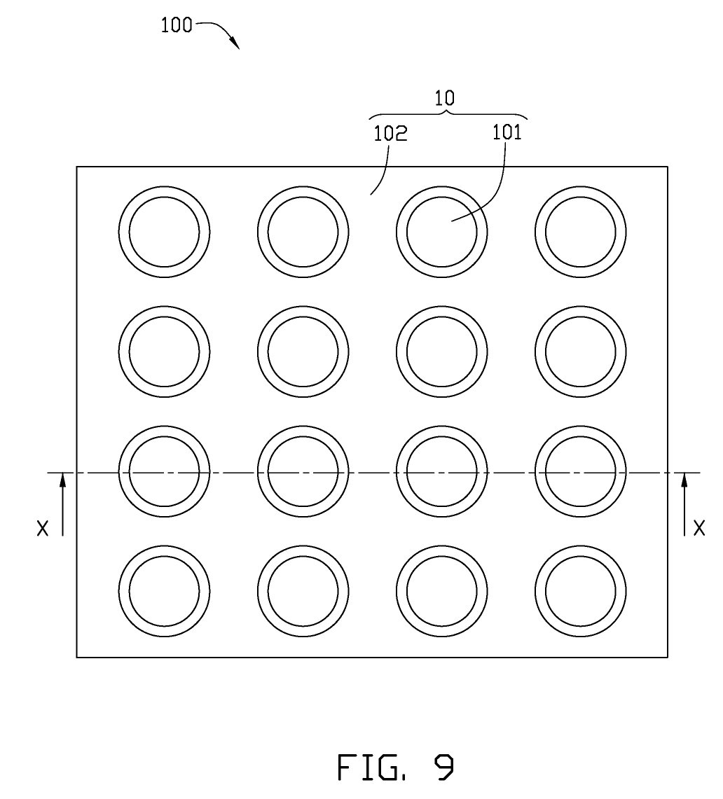

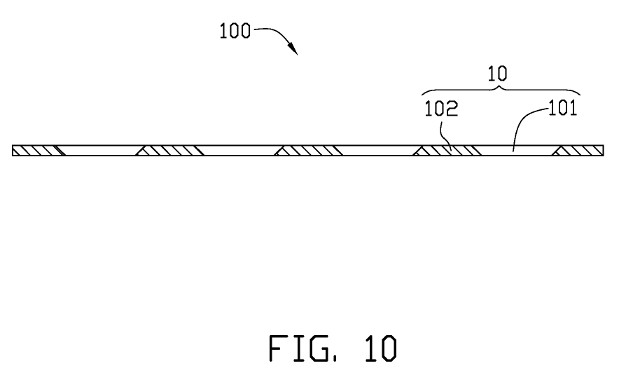

Then, the to-be-solidified film 308 is solidified. Subsequently, the solidified film 308 is separated from the substrate 30 and the conical frustums 304, thus obtaining a light blocking plate module 100 of FIGS. 9-10. The light blocking plate module 100 includes a plurality of through holes 101 corresponding the respective conical frustums 304.

Lastly, the light blocking plate module 100 is cut into a plurality of light blocking plates, one of which is shown in FIGS. 1-2.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

1. A method for making a plurality of light blocking plates, the method comprising:
forming a plurality of conical frustums on a metal substrate, each of the conical frustums tapering in a direction away from the metal substrate;
forming an opaque film on the metal substrate, the film being comprised of a polydimethylsiloxane (PDMS), a blackening agent, and a hardener, each of the conical frustums extending through the film;
solidifying the film;
separating the solidified film from the metal substrate and the conical frustums, thus obtaining a light blocking plate module comprising a plurality of light blocking plates each having a through hole corresponding the respective conical frustum; and
cutting the light blocking plate module into a plurality of individual light blocking plates.

2. The method of claim 1, wherein the conical frustums are formed using ultra-precision machining.

3. The method of claim 1, further comprising forming a release agent layer on the metal substrate, before the film is formed, for facilitating detaching the film from the metal substrate.

4. The method of claim 1, wherein a height of each conical frustum relative to the metal substrate is greater than a thickness of the film.

5. (canceled)

6. A method for making a plurality of light blocking plates, the method comprising:
forming a plurality of cones on a metal substrate, each of the cones tapering in a direction away from the metal substrate;
forming an opaque film on the metal substrate, the film being comprised of a polydimethylsiloxane (PDMS), a blackening agent, and a hardener, each of the cones extending through the film;
solidifying the film;
separating the solidified film from the metal substrate and the cones, thus obtaining a light blocking plate module comprising a plurality of light blocking plates each having a through hole corresponding the respective cone; and
cutting the light blocking plate module into a plurality of individual light blocking plates.

7. The method of claim 6, wherein the cones are formed using ultra-precision machining.

8. The method of claim 6, further comprising forming a release agent layer on the metal substrate, before the film is formed, for facilitating detaching the film from the metal substrate.

9. The method of claim 6, wherein a height of each cone relative to the metal substrate is greater than a thickness of the film.

10. (canceled)

11. The method of claim 1, wherein a thickness of the film is in an approximate range from 10 μm to 30 μm.

12. The method of claim 6, wherein a thickness of the film is in an approximate range from 10 μm to 30 μm.
